(19) United States
(12) Patent Application Publication
(10) Pub. No.: US 2004/0027759 A1
(43) Pub. Date: Feb. 12, 2004

(54) Overcurrent detecting circuit

(75) Inventor: Masaaki Katoh, Tokyo (JP)

Correspondence Address: LEYDIG VOIT & MAYER, LTD, 700 THIRTEENTH ST. NW, SUITE 300, WASHINGTON, DC, 20005-3960, US

(73) Assignees: Mitsubishi Denki Kabushiki Kaisha, Tokyo (JP); Mitsubishi Electric Engineering Company Limited, Tokyo (JP)

(21) Appl. No.: 10/341,580

(22) Filed: Jan. 14, 2003

(30) Foreign Application Priority Data
Aug. 9, 2002 (JP) 2002-233688

(51) Int. Cl. H02H 3/08

(52) U.S. Cl. 361/93.7

(57) ABSTRACT

In an overcurrent detecting circuit, a judgment circuit comprises a reference voltage generating circuit for detecting an overcurrent flowing to an output circuit by utilizing resistor of a wire that connects a lead member provided in an IC package and the output circuit formed on a semiconductor chip and switching transistors for generating a judgment signal indicative of detection of the overcurrent by controlling the reference voltage generating circuit.

### BACKGROUND OF THE INVENTION

1. Field of the Invention

The present invention relates to an overcurrent detecting circuit utilizing a wire which is a constituent of an IC as a detecting element for detecting an overcurrent flowing to an output circuit of a digital amplifier.

2. Description of Related Art

FIG. 2 is a circuit diagram schematically showing a conventional overcurrent detecting circuit.

Referring to FIG. 2, reference numeral 100 denotes a semiconductor chip mounted on an IC, 101 denotes an output circuit of a digital amplifier, which is partially shown and provided in the IC, 102 denotes a judgment circuit and 103 denotes a control circuit. Reference numeral 111 denotes a resistor having a resistance value R1 of a wire that connects a lead of an external electrode of the IC or the like with a pad of the semiconductor chip 100. Reference numeral 112 denotes a resistor having a resistance value R2, 113 denotes a resistor having a resistance value R3, 114 denotes a resistor having a resistance value R4, 115 denotes a resistor having a resistance value R5 of a wire that connects a lead member, to which an external electrode of the IC or the like is connected with a pad of the semiconductor chip 100, 116 denotes a resistor having a resistance value R6, reference character Q1 denotes, e.g., a PNP type bipolar switching transistor, Q2 denotes, e.g., an NPN type bipolar switching transistor and Tr1 and Tr2 denote MOS output transistors. The output circuit 101 of the digital amplifier includes the resistor 111 which is a resistance component of the wire that connects the lead member of the IC with the semiconductor chip, the resistor 116 provided in the semiconductor chip 100 and whose one end is connected in series to the resistor 111, and the output transistors Tr1 and Tr2 connected to the other end of the resistor 116. One end of the output transistor Tr2 is grounded. Because the resistors 111 and 115 are the resistance components of the wire, the respective resistance values R1 and R5 of the resistors 111 and 115 are each smaller than those of the resistors provided in the semiconductor chip 100.

The conventional overcurrent protecting circuit of FIG. 2 is a circuit for monitoring a current I1 flowing to the output circuit 101 of the digital amplifier and for protecting breakage of the output circuit 101 due to the overcurrent. The circuit includes the resistors 111 and 116 for detecting the current I1 flowing to the output circuit 101, the judgment circuit 102 for judging whether the current I1 flowing to the resistors 111 and 116 is an overcurrent or not and the control circuit 103 for controlling the output circuit 101 on the basis of the result of the judgment circuit 102.

The operation of the conventional overcurrent detecting circuit will now be described.

The output circuit 101 supplies supply voltage VD to the output transistors Tr1 and Tr2 provided therein through the resistors 111 and 116 connected in series and individually drives a high-level output signal and a low-level output signal to output these signals. The judgment circuit 102 has a capability of shifting the output level of the judgment signal so that the judgment signal indicative of the overcurrent can be inputted to the control circuit 103 powered by a supply voltage VDD.

The switching transistor Q1 which is a constituent of the judgment circuit 102, to an emitter of which the supply voltage VD is supplied through the resistor 115 using the resistance component of the wire. A base of the switching transistor Q1 is connected to a junction between the resistor 116 and the output transistor TR1 in the output circuit 101, and when the current I1 flowing to the output circuit 101 amounts to an abnormal overcurrent, a significant voltage drop occurs, which is different from a voltage drop caused by a normal operation at both ends of the resistors 111 and 116 connected in series, and a large amount of base current over a predetermined value flows to the switching transistor Q1 of the judgment circuit 102. When the value of the voltage drop I1·(R1+R6) occurring at both ends of the resistors 111 and 116 becomes larger than base-emitter voltage Vbe of the switching transistor Q1 of the judgment circuit 102, the base current of the switching transistor Q1 becomes larger than the predetermined value and the switching transistors Q1 and Q2 are brought into an ON state.

Since the switching transistor Q2 in ON state brings about an increased collector current flowing thereto and suffers from a voltage drop caused by the resistor 114 which supplies the supply voltage VDD to a collector of the switching transistor Q2, voltage at a junction between the resistor 114 and the collector of the switching transistor Q2 decreases and the judgment circuit 102 outputs a low-level judgment signal to the control circuit 103.

When the output circuit 101 is in normal operation, since the voltage drop at both ends of the resistors 111 and 116 connected in series, i.e., the voltage drop caused by the resistance value (R1+R6) is small, the switching transistors Q1 and Q2 of the judgment circuit 102 are brought into an OFF state and the judgment circuit 102 outputs a high-level judgment signal to the control circuit 103. Since the control circuit 103 is powered by the supply voltage VDD as discussed above, as shown in FIG. 2, it supplies the supply voltage VDD to the resistor 114 which is a constituent of the judgment circuit 102 and shifts the level of the signal to be outputted from the judgment circuit 102 to the control circuit 103 so as to conform the level of the signal with the supply voltage VDD.

When the high-level judgment signal is outputted from the judgment circuit 102, the control circuit 103 supplies normal gate voltage to respective gates of the output transistors Tr1 and Tr2 of the output circuit 101 and outputs signals individually driven by the output transistors Tr1 and Tr2 from the output circuit 101. When the low-level judgment signal is outputted from the judgment circuit 102, the control circuit 103 controls the gate voltage of the output transistors Tr1 and Tr2, and brings the output circuit 101 into a high impedance state, thereby preventing breakage due to the overcurrent value.

Since in the conventional overcurrent detecting circuit the resistor 111 which is the resistance component of the wire has a small resistance value R1 as discussed above, and undergoes very small change in voltage drop generated at both ends of the resistor 111 with a change in the current I1a, the resistance value R6 of the resistor 116 is controlled so as to ensure detection of the overcurrent from the output circuit 101.

Since the conventional overcurrent detecting circuit is configured as above, the output characteristics of the digital amplifier, such as the S/N ratio and the distortion factor, are deteriorated, unless the resistance value present on a signal path of the output circuit is made as small as possible, and the resistance ratio of the output transistor which drives both the high-level output signal and the low-level output signal is made 1:1 in an output operation. Thus, the conventional overcurrent detecting circuit deteriorates output characteristics of, particularly, the high-level output signal by the reason that the resistance value of the resistance element for detecting the overcurrent adversely affects the characteristics of the output circuit and a total resistance value of the output circuit becomes larger due to the presence of the resistance element provided for secure detection of the overcurrent.

### SUMMARY OF THE INVENTION

The present invention has been made to solve the above problems and an object thereof is to provide an overcurrent detecting circuit which can alleviate to a minimum adverse effects on characteristics of, e.g., the output circuit, a target for detection of the overcurrent, by using the resistance component of the wire that connects the lead member provided in the IC with the semiconductor chip as a resistor for detecting the overcurrent.

The overcurrent detecting circuit according to the present invention includes overcurrent detecting means for detecting an overcurrent flowing to an output circuit by utilizing a resistance component of a wire that connects a lead member provided in an IC package and the output circuit formed on a semiconductor chip and a switching transistor for generating a judgment signal indicative of detection of the overcurrent by controlling the overcurrent detecting means.

According to the present invention, it is possible to reduce the resistance value used for detection of the overcurrent and alleviate to a minimum adverse effects of the circuit, a target for detection of the overcurrent.

### BRIEF DESCRIPTION OF THE DRAWINGS

FIG. 1 is a circuit diagram schematically showing an overcurrent detecting circuit of a first embodiment of the present invention; and

FIG. 2 is a circuit diagram schematically showing a conventional overcurrent detecting circuit.

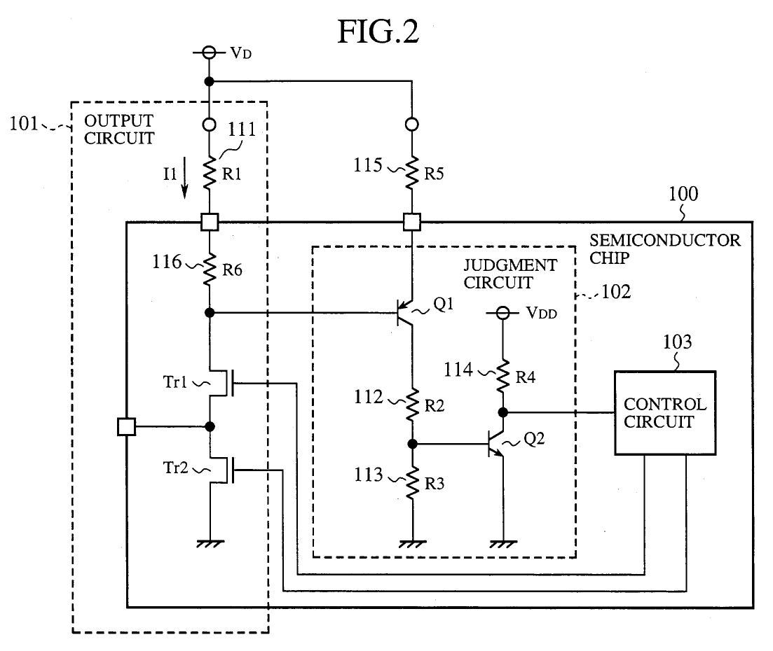

### DETAILED DESCRIPTION OF THE PREFERRED EMBODIMENT

A preferred embodiment of the present invention will be described with reference to the attached drawing.

### First Embodiment

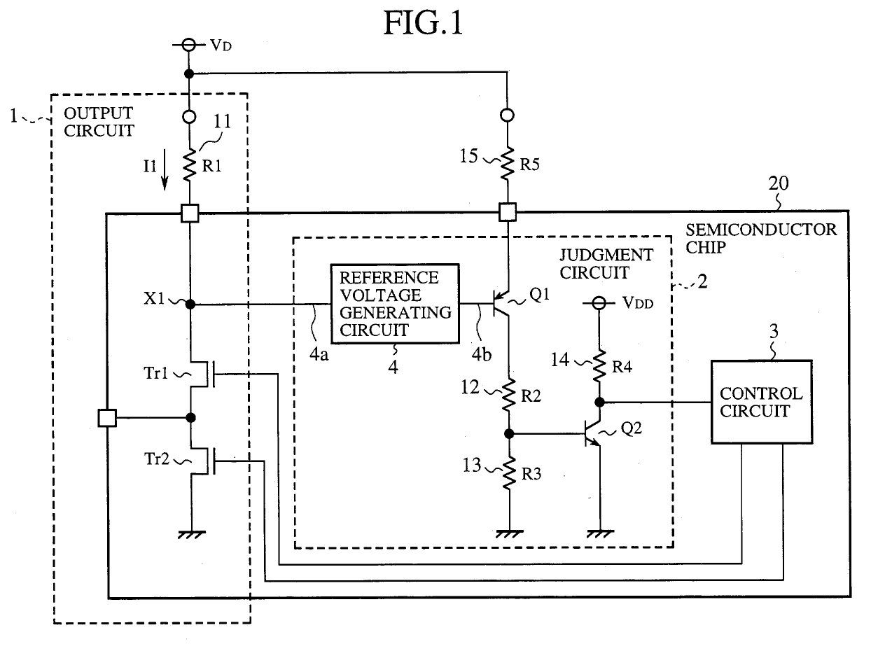

FIG. 1 is a circuit diagram schematically showing an overcurrent detecting circuit of the first embodiment of the present invention.

Referring to FIG. 1, reference numeral 1 denotes an output circuit of a digital amplifier, which is partially shown, 2 denotes a judgment circuit for judging whether a current 11 flowing to the output circuit 1 is an overcurrent or not, 3 denotes a control circuit for controlling the output circuit 1, 4 denotes a reference voltage generating circuit (overcurrent detecting means) provided in the judgment circuit 2, reference character 4a denotes a junction of the reference voltage generating circuit 4, which connects the reference voltage generating circuit 4 and the output circuit 1, 4b denotes a junction of the reference voltage generating circuit 4, which connects the reference voltage generating circuit 4 and the base of the switching transistor Q1 of the judgment circuit 2, 11 denotes a resistor (resistance component of a wire) having a resistance value R1, 12 denotes a resistor having a resistance value R2, 13 denotes a resistor having a resistance value R3, 14 denotes a resistor having a resistance value R4, 15 denotes a resistor having a resistance value R5, Tr1 and Tr2 denote MOS output transistors, Q1 denotes, e.g., a PNP type bipolar switching transistor, Q2 denotes, e.g., an NPN type bipolar switching transistor, 20 denotes a semiconductor chip mounted on an IC and X1 denotes a detecting point connected to the junction 4a of the reference voltage generating circuit 4, for detecting the overcurrent of the output circuit 1 by monitoring a voltage drop caused by the resistor 11 of the output circuit 1.

The resistors 11 and 15 are wires that connect a lead member or the like provided in the IC package and a pad or the like provided in the semiconductor chip 20, and the resistance components of these wires are used as the resistors 11 and 15 in the overcurrent detecting circuit of the first embodiment.

The output circuit 1 of the digital amplifier shown in FIG. 1 includes the resistor 11, to one end of which the supply voltage VD is supplied and the output transistor Tr1 connected to the other end of the resistor 11, for driving a high level (hereinafter, referred to as “H”) output signal and the output transistor Tr2 connected to the output transistor Tr1, for driving a low level (hereinafter, referred to as “L”) output signal. Either source or drain of the output transistor Tr2, to which the output transistor Tr1 is not connected, is grounded. To a portion at which either source or drain of the output transistor Tr1 is connected with the resistor 11, the junction 4a of the reference voltage generating circuit 4 is connected, and the detecting point X1 is formed thereat.

The judgment circuit 2 comprises the switching transistor Q1, to an emitter of which the supply voltage VD is supplied through the resistor 15, a base of which is connected to the junction 4b of the reference voltage generating circuit 4 and a collector of which is grounded through the resistors 12 and 13 connected in series; the switching transistor Q2, a base of which is connected to a junction between the resistors 12 and 13, an emitter of which is grounded, and to a collector of which the supply voltage VDD is supplied through the resistor 14; and the reference voltage generating circuit 4.

The control circuit 3 is connected to the judgment circuit 2 such that the judgment signal is supplied from the collector of the switching transistor Q2 provided in the judgment circuit 2, and such that the gate voltages of the output transistors Tr1 and Tr2 provided in the output circuit 1 are controlled.

The operation of the overcurrent detecting circuit of the first embodiment will next be described.

The output circuit 1 supplies the supply voltage VD to the output transistors Tr1 and Tr2 through the resistor 11, the resistance component of the wire, the output transistor Tr1 drives, e.g., a high-level judgment signal and the output transistor Tr2, e.g., a low-level judgment signal, to take an output signal out from a portion at which the source or drain of the output transistor Tr1 and the output transistor Tr2 is connected and to output the output signal from the semiconductor chip.

The reference voltage generating circuit 4 in the judgment circuit 2 generates, e.g., voltage which is supplied to the source or drain of the output transistor Tr1, e.g., when the output circuit 1 is in normal operation, i.e., reference voltage Vref1 equal to voltage of a portion at which the resistor 11 and the output transistor Tr1 are connected. Further, the junction 4a is connected to the detecting point X1 of the output circuit 1 as discussed above, a voltage drop caused by the resistor 11, i.e., voltage supplied to the output transistor Tr1 is monitored at the detecting point X1 and the voltage at the detecting point X1 is compared with the reference voltage Vref1, thereby monitoring a change in the current 11 flowing to the resistor 11.

When the voltage at the detecting point X1 is equal to the reference voltage Vref1, e.g., the reference voltage generating circuit 4 judges that the normal operating current 11 flows to the output 1 and prevents the current from flowing to the base of the switching transistor Q1 of the judgment circuit 2 connected to the junction 4b, to bring the switching transistors Q1 and Q2 which are constituents of the judgment circuit 2 into an OFF state. When the switching transistor Q2 is in the OFF state, since no collector current of the switching transistor Q2 flows, the high-level judgment signal obtained by voltage drop of the supply voltage VDD with the resistance value R4 of the resistor 14 is outputted to the control circuit 3. The judgment circuit 2 shown in FIG. 1 outputs the high-level judgment signal when the current I1 flowing to the resistor 11 of the output circuit 1 is a normal value, and outputs the low-level judgment signal when the current I1 flowing to the resistor 11 is an overcurrent.

Since the voltage at the junction 4a in the reference voltage generating circuit 4 varies when the current I1 flowing to the resistor 11 of the output circuit 1 is the overcurrent, e.g., the voltage at the detecting point X1 becomes equal to the reference voltage Vref1, the reference voltage generating circuit 4 drives a base current of the switching transistor Q2 of the judgment circuit 2, to bring the switching transistor Q1 into an ON state. Specifically, when the overcurrent flows to the output circuit 1, a voltage drop represented by I1·R1, occurring at both ends of the resistor 11, increases and the voltage at the detecting point X1 and the reference voltage Vref1 lose the balance, resulting in a change in voltage at the junction 4a of the reference voltage generating circuit 4. The reference voltage generating circuit 4 drives the base current flowing from the junction 4b to the switching transistor Q1 on the basis of the voltage change at the junction 4a, to bring the switching transistor Q1 into the ON state.

In passing, the value of the reference voltage Vref1 is not limited to one equal to the voltage at the detecting point X1 when the normal current I1 flows to the output circuit 1. Alternatively, it may be set to a given difference therebetween and when the overcurrent flows to the output circuit 1, the relation between the reference voltage Vref1 and the voltage at the detecting point X1 changed to detect the overcurrent by the reference voltage generating circuit 4.

From other point of view, an attempt at discussing the detection of overcurrent in the output circuit. 1 by the reference voltage generating circuit 4 is made. Since the resistor 11 has a small resistance value R1, the voltage drop occurring at both ends of the resistor 11 does not show a great change even if the current I1 undergoes a significant change. Then, the reference voltage generating circuit 4 is configured so that the reference voltage Vref1 is added in appearance to the voltage drop at the resistor 11, i.e., potential represented by I1·R1+Vref1, to the base of the switching transistor Q1. When the overcurrent flowed, the value I1·R1+Vref1 increases as compared with the normal condition. When this value becomes larger than the base-emitter voltage Vbe of the switching transistor Q1, the switching transistor Q1 is turned ON, to carry the base current. Here, for example, the reference voltage Vref1 is set so that it closes to the threshold at which the ON/OFF state of the switching transistor Q1 is switched, and configured so that the ON/OFF state of the switching transistor Q1 is switched due to a small change in the I1·R1 of the voltage drop of the resistor 11.

The judgment circuit 2 monitors a change in the voltage drop of the resistor 11 by using the reference voltage generating circuit 4 as discussed above and judges whether the current I1, obtained by the voltage drop, flowing to the resistor 11 is the overcurrent or not, and switches ON/OFF state of the switching transistor Q1. When the overcurrent flowed, the reference voltage generating circuit 4 drives the base current of the switching transistor Q1 to bring the switching transistor Q1 into the ON state and conducts the supply voltage VD supplied to the emitter of the switching transistor Q1 to the collector through the resistor 15, and biases the switching transistor Q2 with the resistors 12 and 13, to bring the switching transistor Q2 into the ON state. The switching transistor Q2 in the ON state brings about an increased collector current and yields the large voltage drop of the supply voltage VDD which is occurred at the resistor 14 connected to the collector. The voltage at the junction between the resistor 14 and the collector of the switching transistor Q2 becomes low level, and the judgment circuit 2 outputs the low-level judgment signal.

When the judgment circuit 2 judged that no overcurrent is detected in the output circuit 1, in other words, the normal current I1 flows to the resistor 11 and the relation between the voltage drop caused by the resistor 11 and the reference voltage Vref1 is constant and keeps balance, the reference voltage generating circuit 4 controls the base current so that the switching transistor Q1 comes into the OFF state, to bring the switching transistors Q1 and Q2 into the OFF state. Since the switching transistor Q2 comes into the OFF state, the collector current flowing to the switching transistor Q2 is blocked. Then, since the supply voltage VDD is applied to the junction between the resistor 14 and the switching transistor Q2 through the resistor 14, the junction shows a high level and the judgment circuit 2 outputs the high-level judgment signal.

Further, since the control circuit 3 is powered by the supply voltage VDD smaller than the supply voltage VD supplied to the output circuit 1 and the switching transistor Q1 of the judgment circuit 2 and the like, the judgment circuit 2 performs a level shift with the switching transistor Q2 and the resistor 14 so that the H or L level can be inputted to the control circuit 3.

The control circuit 3 controls the respective gate voltages of the output transistors Tr1 and Tr2 provided in the output circuit 1 on the basis of the high-level judgment signal or the low-level judgment signal outputted from the judgment circuit 2. When the high-level judgment signal indicative of no detection of the overcurrent is inputted from the judgment circuit 2, the control circuit 3 supplies the gate voltages to the gates of the output transistors Tr1 and Tr2 for driving the H level output signal and the L level output signal of the digital amplifier, respectively. Conversely, when the low-level judgment signal indicative of detection of the overcurrent is inputted from the judgment circuit 2, the control circuit 3 controls the respective gate voltages of the output transistors Tr1 and Tr2 to bring the output circuit 1 into a high impedance state, thereby preventing breakage of the output circuit 1 due to the overcurrent.

Since the overcurrent protecting device of the first embodiment uses the resistance component of the wire as the resistor 11, the resistance value R1 of the resistor 11 is small and therefore the voltage drop occurring at both ends of the resistor 11 is also small. Even by controlling the resistance value R1, it is difficult to control the value of the overcurrent to be detected within an effective range. Then, the current value which is judged as an overcurrent in the output circuit 1 is determined by appropriately setting the reference voltage Vref1 generated by the reference voltage generating circuit 4 and using the switching transistor Q1 having an appropriate switching characteristic in consideration of the reference voltage Vref1 in the judgment circuit 2.

As discussed above, according to the first embodiment, since the resistance component of the wire which is a constituent of the IC is used as the resistor 11 and the small voltage drop caused by the resistance value R1 of the resistor 11 is monitored by the reference voltage generating circuit 4 to detect the overcurrent in the output circuit 1, it is possible to reduce the total resistance value in the output circuit 1, alleviate adverse effects on the dynamic characteristics of the output transistors Tr1 and Tr2 in the output circuit 1 and detect the overcurrent without deteriorating the output characteristic of the output circuit 1.

What is claimed is:

1. An overcurrent detecting circuit comprising an output circuit for outputting a signal driven by an output transistor; a judgment circuit for detecting an overcurrent from said output circuit to output a judgment signal; and a control circuit for blocking said overcurrent flowing to said output circuit on the basis of said judgment signal inputted from said judgment circuit, wherein said judgment circuit comprises
overcurrent detecting means for detecting said overcurrent flowing to said output circuit by utilizing a resistance component of a wire that connects a lead member provided in an IC package and said output circuit formed on a semiconductor chip; and
a switching transistor for generating said judgment signal indicative of detection of said overcurrent by controlling said overcurrent detecting means.

2. The overcurrent detecting circuit according to claim 1, wherein said overcurrent detecting means monitors a voltage drop caused by said resistance component of said wire which supplies power supply voltage to said output circuit, and controls said switching transistor to generate said judgment signal indicative of detection of said overcurrent when said overcurrent detecting means detects said voltage drop larger than a predetermined value.

3. The overcurrent detecting circuit according to claim 2, wherein said overcurrent detecting means generates a predetermined reference voltage and detects said voltage drop caused by said resistance component of said wire with said reference voltage.
